(19) United States
(12) Patent Application Publication
(10) Pub. No.: US 2022/0345785 A1
(43) Pub. Date: Oct. 27, 2022

(54) METHOD FOR PLAYING IMAGE, ELECTRONIC DEVICE AND STORAGE MEDIUM

(71) Applicant: BEIJING DAJIA INTERNET INFORMATION TECHNOLOGY CO., LTD., Beijing (CN)

(72) Inventors: Qiu YANG, Beijing (CN); Ge SONG, Beijing (CN); Hui LI, Beijing (CN); Long LI, Beijing (CN)

(21) Appl. No.: 17/725,067

(22) Filed: Apr. 20, 2022

(30) Foreign Application Priority Data
Apr. 21, 2021 (CN) 202110432790.0

(51) Int. Cl. H04N 21/472; H04N 21/482; H04N 21/258; G06F 3/0482; G06F 3/04886

(52) U.S. Cl. CPC H04N 21/47217; H04N 21/4821; H04N 21/25825; G06F 3/0482; G06F 3/04886

(57) ABSTRACT

A method for displaying an image, an electronic device and storage medium are provided. The method includes: displaying, on a display interface of an information flow list, at least one resource in the information flow list; obtaining, in response to a first resource of the at least one resource being an image group and a position of an image container containing the image group being within a preset range of a screen, at least one image of the image group; and playing, according to a type of the image group, the at least one image of the image group dynamically.

### CROSS-REFERENCE TO RELATED APPLICATION

The present disclosure claims priority to Chinese Patent Application No. 202110432790.0, titled METHOD FOR PLAYING IMAGE, ELECTRONIC DEVICE AND STORAGE MEDIUM, filed on Apr. 21, 2021, in the China National Intellectual Property Administration, the entire contents of which are incorporated herein by reference.

### TECHNICAL FIELD

The present disclosure relates to the field of image display technology and, in particular, to methods, electronic devices, and storage media playing an image.

### BACKGROUND

In the related art, the content consumption products that contain video type products can be recommended in a mixed arrangement of images and videos on the list page, or alternatively can be recommended by distinguishing the content types on the list page. However, in either method, when displaying an image group containing one or more images on the list page, generally only a thumbnail of a cover of the image group can be displayed. Since the thumbnail is obtained by cropping and compressing the cover, the display quality of the thumbnail is poorer than the original image. In addition, users can only judge whether they are interested through the thumbnail of the cover in the process of finding the content on the list page, and can only view the complete image or all the images by clicking into the image view page.

As can be seen that the list page can only display a static thumbnail of the cover of the image group, and the complete contents of the image group can only be viewed by user operation. Furthermore, even in the image view page, the contents of the image group can only be switched by the user swiping up/down/left/right, which is tedious and burdensome for users to operate.

### SUMMARY

The present disclosure provides methods, electronic devices, and storage media for playing an image.

According to some arrangements of the present disclosure, a method for playing an image includes displaying, on a display interface of an information flow list, at least one resource in the information flow list, obtaining, in response to a first resource of the at least one resource being an image group and a position of an image container containing the image group being within a preset range of a screen, at least one image of the image group, and playing, according to a type of the image group, the at least one image of the image group dynamically.

According to some arrangements of the present disclosure, an electronic device includes a processor and a memory for storing instructions executable by the processor. The processor is configured to execute the instructions to implement a method for playing an image as described herein.

According to yet some arrangements of the present disclosure, a computer readable storage medium storing instructions such that, when the instructions in the computer storage medium are executed by a processor of an electronic device, enables the electronic device to perform a method for playing an image as described herein.

According to some arrangements of the present disclosure, a computer program product including a computer program or computer instructions, which implements the method for playing an image as described herein when executed by a processor.

It should be understood that the foregoing general description and the following detailed description are exemplary and explanatory only and do not limit the present disclosure.

### BRIEF DESCRIPTION OF THE DRAWINGS

The accompanying drawings, incorporated into and form part of the specification, illustrate arrangements consistent with the present disclosure, and are used in conjunction with the specification to explain the principles of the present disclosure and do not constitute an undue limitation of the present disclosure.

FIG. 1 is a flow chart of a method for playing an image illustrated according to some arrangements of the present disclosure.

FIG. 2 is a flow chart of a method for playing an image illustrated according to some other arrangements of the present disclosure.

FIG. 3 is a schematic diagram of a display position of an image operation control illustrated according to some arrangements of the present disclosure.

FIG. 4 is a schematic diagram of a display position of a next work control illustrated according to some arrangements of the present disclosure.

FIG. 5 is a schematic diagram of a full-screen image playback interface displayed as two regions illustrated according to some arrangements of the present disclosure.

FIG. 6 is a block diagram of an apparatus for playing an image illustrated according to some arrangements of the present disclosure.

FIG. 7 is a block diagram of an electronic device illustrated according to some arrangements of the present disclosure.

### DETAILED DESCRIPTION

In order to enable a person of ordinary skill in the art to better understand the technical solutions of the present disclosure, the technical solutions in the arrangements of the present disclosure will be clearly and completely described below with reference to the accompanying drawings.

It should be noted that the terms “first,” “second,” etc. in the specification, claims and the above accompanying drawings of the present disclosure are used to distinguish similar objects, but not necessarily be used to describe a particular order or sequence. It should be understood that the terms so used are interchangeable under appropriate circumstances so that the arrangements of the disclosure described herein can be practiced in sequences other than those illustrated or described herein. The implementations described in the exemplary arrangements below are not intended to represent all implementations consistent with this disclosure. Rather, they are merely examples of apparatus and methods consistent with some aspects of the present disclosure as recited in the appended claims.

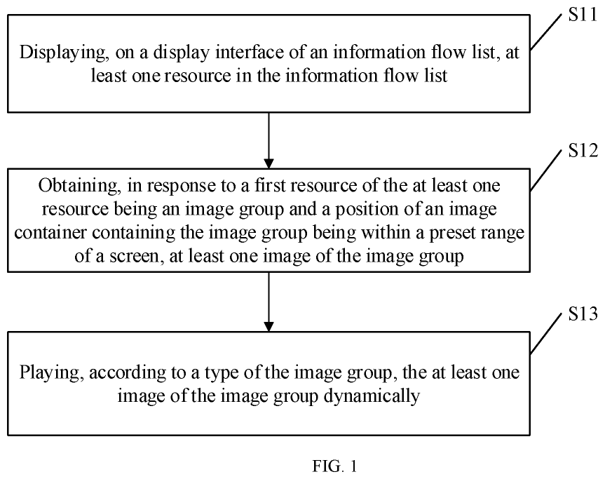

FIG. 1 is a flow chart of a method for playing an image illustrated according to some arrangements of the present disclosure. As shown in FIG. 1, the method for displaying the image is applicable to electronic devices such as cell phones, tablet computers, etc. with a display.

At S11, at least one resource in an information flow list is displayed on a display interface of the information flow list.

The information flow list includes one or more image resources. The information flow list may further include at least one of a video resource and a live streaming resource.

In this arrangement of the present disclosure, the image resources can be arranged in a mix with the video resources and/or live streaming resources in the information flow list by playing the images dynamically, so that the resources of multiple resource types can be displayed on the display interface of the information flow list. Each resource may be a work published by a user.

At S12, in response to a first resource of the at least one resource being an image group and a position of an image container containing the image group being within a preset range of a screen, at least one image of the image group is obtained.

The preset range is the range of positions in the screen where the image resources can be dynamically previewed, which can generally be the range in the middle of the screen, for example, it can be the range from 1/3 to 2/3 of the screen, etc.

The one or more resources in the information flow list will be displayed based on user operations on the display interface of the information flow list. When a first resource (e.g., the current resource being displayed) is an image resource and the image resource is an image group, the current position of the image container containing the image group on the screen is obtained. When the current position is in a preset range, at least one image of the image group is obtained from the database storing the image resources.

At S13, the at least one image of the image group is dynamically played according to a type of the image group.

The type of the image group may include a long image, multi-image, or an image collection. The type of the image group is the long image, which means that the image group includes a long image that is longer than a normal image in height and usually includes of multiple normal images stitched together along a lengthwise axis of the long image. In the case where the type of the image group is the multi-image or the image collection, the image group includes a plurality of images. Different from the multi-image type, the image collection is a collection of multiple sub-image groups, that is, the image group belonging to the type of image collection includes multiple sub-image groups, and each sub-image group includes multiple images. For example, one image group belonging to the type of image collection is named “cute couple avatar”, and the image collection may contain “anime avatar” sub-image group, “cute pet avatar” sub-image group, “cute baby avatar” sub-image group, etc.

The at least one image of the image group is dynamically played in different video formats and at a preset playback speed based on the type of image group. For example, for a long image, the long image is presented staring from the top of the long image and is played in dynamic upward motion, while for multiple images or an image collection, multiple images in the image group are dynamically switched for dynamic playback.

In an exemplary arrangement, the playing, according to the type of the image group, the at least one image of the image group dynamically.

In response to the type of the image group being a long image, the long image of the image group is moved dynamically upwards within the image container at a preset long image playback speed.

In response to the type of the image group being multi-image, the at least one image is dynamically switchable within the image container at a preset multi-image playback speed.

In response to the type of the image group being an image collection, the at least one image of each sub-image group in the image collection is dynamically switchable within the image container at a preset multi-image playback speed in an order of a plurality of sub-image groups in the image collection.

Here, the long image playback speed may be the speed of moving pixels, for example, it may be 40 pixels per second. The multi-image playback speed may be the speed of switching images, for example, switching from one image to another image every 2 seconds.

When the type of the image group is the long image, the long image can be dynamically moved up from the top of the long image in the image container at a preset long image playback speed, so that the long image can be displayed with dynamic effects without user operation, and the whole long image can be displayed in its entirety dynamically by automatically moving from the top of the long image to the bottom of the long image. When the type of the image group is multi-image, the playback can be started from the first image of the image group within the image container in an order of at least one image in the image group at a preset multi-image playback speed, and during playback, the at least one image of the image group is dynamically switchable. Until the last image of the image group is played out the playback of the image group is completed. When the type of the image group is an image collection, the image collection includes a plurality of sub-image groups, i.e., the image group includes a plurality of sub-image groups, and each sub-image group includes at least one image. In this case, at least one image of each sub-image group in the image collection is dynamically switchable within the image container in an order of a plurality of sub-image groups in the image collection at a preset multi-image playback speed. Therefore, according to the type of the image group, each image in the image group is displayed dynamically by using a playback format that corresponds to the type of the image group, so that all image(s) in the image group can be displayed without user operation, simplifying user operation.

In an exemplary arrangement, switching the at least one image dynamically within the image container, includes: changing gradually from displaying the at least one image with a transparency of 100% to displaying the at least one image with a transparency of 0%; and changing gradually, in response to the at least one image being displayed for a preset time with the transparency of 0%, to display the at least one image with the transparency of 100%. In the case where the type of the image group is the multi-image or the image collection, when dynamically switching between images within the image container, the transparency of the current image gradually changes from 0 to 100% once switching to the current image, and then, in response to the current image being displayed for the preset time with the transparency of 100%, the transparency of the current image gradually changes from 100% to 0. After that, it switches to the next image, whose transparency is also changed in this way. Therefore, the dynamic switching in the form of fading in and out is achieved, i.e., when the current image is about to end, the current image is gradually put away and the next image is gradually displayed, which further enhances the dynamic effect of the image display.

In an arrangement, the method further includes: playing, in response to the type of the image group being the long image or the multi-image and the at least one image of the image group having been displayed, the at least one image on a loop according to a playback form of the long image or the multi-image. In the case where the type of the image group is the long image or the multi-image, after all image(s) in the image group has or have been played, at least one image in the image group is played in a loop from the beginning in accordance with the playback form of the long image or the multi-image. The display of dynamic effects on the image group for a long time is achieved by looping.

In another arrangement, the method further includes: playing, in response to the type of the image group being the image collection and the plurality of sub-image groups in the image collection having been displayed, the at least one image of each sub-image group in the image collection on a loop according to a playback form of the image collection.

When the type of the image group is the image collection, the image(s) in each sub-image group is or are played dynamically in the order of each sub-image group in the image collection. During playback of the image(s) in each sub-image group, the image(s) in each sub-image group is or are dynamically switchable within the image container at the preset multi-image playback speed. After the playback of one sub-image group is completed, it switches dynamically to one image in the next one sub-image group, and after all the images in the image collection have been played, the image(s) in each sub-image group will be played in a loop. By looping through the image collection, the display of all the sub-image groups of the image collection is achieved and the dynamic effect on each sub-image group of the image collection may also be displayed in a loop.

In an arrangement, the method further includes: playing, during dynamically playing the at least one image of the image group, an audio resource corresponding to the image group. In response to determining that the user adds the audio resource when publishing the image group, the audio resource corresponding to the image group is played simultaneously when the at least one image of the image group is dynamically played, to further improve the video dynamics of the image group.

The method for playing the image provided by these arrangements can realize automatic playback of all image(s) in the image group by dynamically playing at least one image in the image group on the display interface of the information flow list according to the type of the image group, in response to the current position of the image container containing the image group being in a preset range of the screen. In addition, the complete content of the image group can be viewed by the user without operation, thereby simplifying the user operation and improving the user experience. Furthermore, all the image(s) in the image group can be played in the form of video, which can realize the playback of the image resources and video resources using a unified player and the mixed recommendation of images, videos and live streaming contents.

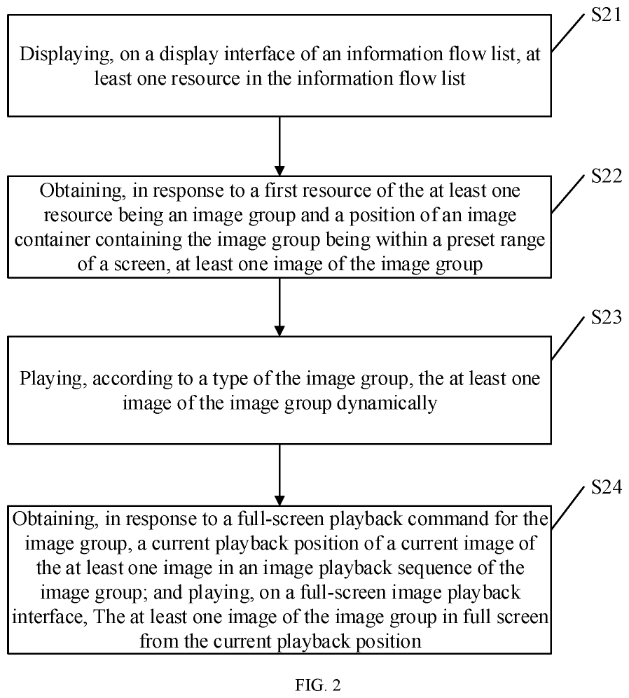

FIG. 2 is a flow chart of a method for playing an image illustrated according to some arrangements of the present disclosure. As shown in FIG. 2, the method for playing the image is applicable to the electronic devices, such as cell phones, tablet computers, etc. with a display.

At S21, at least one resource in an information flow list is displayed on a display interface of the information flow list.

At S22, in response to a first resource of the at least one resource being an image group and a position of an image container containing the image group being within a preset range of a screen, at least one image of the image group is obtained.

At S23, the at least one image of the image group is dynamically played according to a type of the image group.

At S24, in response to a full-screen playback command for the image group, a current playback position of a current image of the at least one image in an image playback sequence of the image group is obtained, and the at least one image of the image group is played in full screen from the current playback position on a full-screen image playback interface.

On the display interface of the information flow list, if the user wants to view the dynamic effects of the image group in full screen base on the dynamic effect of the image in the image group being displayed, he or she can select (e.g., click) on the image group, so that the electronic device determines that a full-screen playback command for the image group is received upon the user select (e.g., click) on the image group is detected. The electronic device obtains a current image of the image group at the time when the full-screen playback command is received, determines a current playback position of the current image in an image playback sequence of the image group, and then, enters a full-screen image playback interface. On the full-screen image playback interface, the at least one image of the image group is played in full screen from the current playback position. Therefore, the full-screen playback of the image in the image group on the full-screen image playback interface starts from the current playback position at the time when the full-screen playback command is received, which achieves the continuous playback of the image group.

If an audio resource was published at the same time when the user published the image group, the audio resource will be played at the same time as the dynamic effect of the image in the image group is played on the display interface of the information flow list. A playback position of the audio resource at the time when the full-screen playback command for the image group is received is obtained. At the same time that the image in the image group is played in full screen on the full-screen image playback interface from the current playback position of the image group, the audio resource keeps playing from the playback position of the audio resource, which achieves the continuous playback of the image group and the audio resource.

In an arrangement, the method further includes: playing, in response to a resource switching command, on the full-screen image playback interface, a second resource in the information flow list, where a type of the second resource includes an image resource, a video resource or a live streaming resource.

Upon detecting that the user swipes up the full-screen image playback interface, the electronic device determines that a resource switching command is received, at which time a second resource (e.g., the next resource after the image group) in the information flow list is played. Since the image resources, video resources and live streaming resources adopt a consistent full-screen player, the type of the second resource may be an image resource, a video resource or a live streaming resource. Since the image resource is played in the form of video, the full-screen player used for the image resource is the same as that used for the video resource, so that different resource types of resources may be switched for viewing according to the user-based resource switching command, achieving a mix recommendation and full immersion consumption of images and other resource types.

In the method for playing the image provided in these arrangements, in response to the full-screen playback command for the image group, the electronic device obtains the current playback position of the current image in the image playback sequence of the image group and enters the full-screen image playback interface from the display interface of the information flow list, and plays the at least one image of the image group in full screen from the current playback position in the full-screen image playback interface, which achieves the continuous playback of the image group on the full-screen image playback interface.

In some arrangements, the method further includes: displaying, on the full-screen image playback interface, interface text information and an interactive function control of the image group; and in response to a pause command, pausing playback of the image group and hiding the interface text information and the interactive function control.

Here, the interface text information may be a text description provided by the user when publishing the image group. The interactive function controls include a follow control, a like control, a comment control and a share control, etc.

When dynamically playing the image of the image group, the interface text information and the interactive function control are displayed on the full-screen image playback interface. For example, the interface text information may be displayed at the bottom of the interface, and the interactive function controls may be displayed vertically in the bottom right corner of the interface. When the user is watching the automatically previewed image group on the full-screen image playback interface, if he or she is interested in a certain image or wants to skip it quickly, he or she can tap the screen, i.e., select (e.g., click) the screen. At this time, a pause command (e.g., a preview pause command) is received by the electronic device from the user, the dynamic effect of the image group is paused, the interface display stays at the position of the image displayed when the pause command is received, and the interface text information and interactive function control are put away, i.e., the interface text information and interactive function control are no longer displayed, in order to maximize the display of the current image in the interface area and facilitate the user to view the details of the current image.

If an audio resource was added when the image group was published, the audio resource can keep playing when the dynamic effect of the image group is paused, i.e., the playback of the audio resource is not interrupted.

In an arrangement, pausing the playback of the image group includes at least one of: in response to the type of the image group being a long image, determining a current display range of the long image when the pause command is received, and displaying the long image within the current display range; and in response to the type of the image group being multi-image or an image collection, determining a currently displayed image when the pause command is received, and displaying the currently displayed image.

When the type of image group is the long image, the interface stays at the position of the long image at the time of automatic preview, i.e., shows the long image within the current display range when the pause command is received. When the type of the image group is multi-image or the image collection, the interface stays at the currently played image, i.e., shows the currently displayed image when the pause command is received. In this way, the display of images of the different image group types during pause is realized.

In some arrangements, the method further includes at least one of the followings.

In response to the type of the image group being the long image and receiving an up and down swipe command, a display range of the long image is changed by moving the long image with the up and down swipe command.

In response to the type of the image group being the multi-image or the image collection and receiving a left and right swipe command, a previous image or a next image of the currently displayed image is displayed.

When the type of image group is the long image, the user can swipe up and down on the screen to change the display range of the long image. When the type of image group is multi-image or the image collection, the user can swipe left and right on the screen to switch the displayed images. The display on the screen is switched according to the user-based swipe command to meet the user's demand of actively viewing images.

In some arrangements, after hiding the interface text information and the interactive function control, the method further includes: displaying, at a first preset position of the full-screen image playback interface, an image operation control, the image operation control including at least one of a favorite image control, a download image control and a recognize image text control; and in response to the image operation control being triggered, performing an operation on the image group.

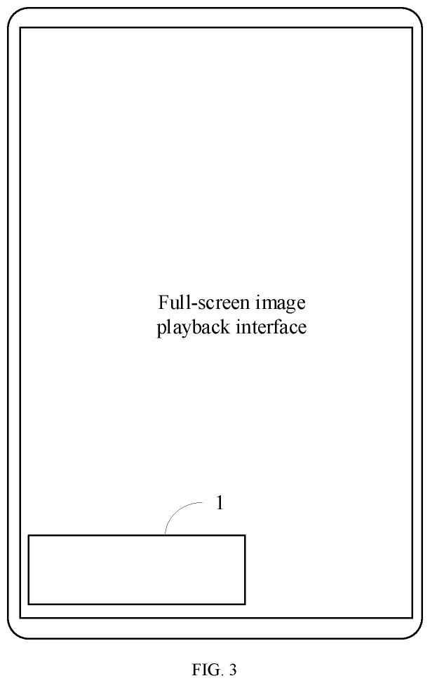

FIG. 3 is a schematic diagram of a display position of an image operation control illustrated according to some arrangements of the present disclosure. As shown in FIG. 3, the first preset position can be the lower left corner position 1 of the full-screen image playback interface, i.e., a plurality of image operation controls may be displayed by horizontal rows in the lower left corner of the full-screen image playback interface. If the user wants to perform an operation on the currently displayed image, the corresponding image operation control can be selected (e.g., clicked), so that the electronic device can receive the operation command and execute the corresponding image operation. For example, when the electronic device detects that the user selects (e.g., clicks) on the favorite image control, it is determined that a command for collecting image is received, and then the operation of collecting the currently displayed image is executed. In response to the electronic device detects that the user selects (e.g., clicks) on the download image control, it is determined that a command for downloading image is received, and then the operation of downloading the currently displayed image is executed. In response to the electronic device detects that the user clicks on the recognize image text control, it is determined that a command for recognizing text is received, and then the operation of recognizing the text of the currently displayed image is executed. When the image group is paused, the image operation control is displayed, which can meet the user's demand for image operation.

In some arrangements, after hiding the interface text information and the interactive function control, the method further includes: displaying, at a second preset position of the full-screen image playback interface, a next work control; and in response to the next work control being triggered, a next resource in the information flow list is displayed based on an operation command.

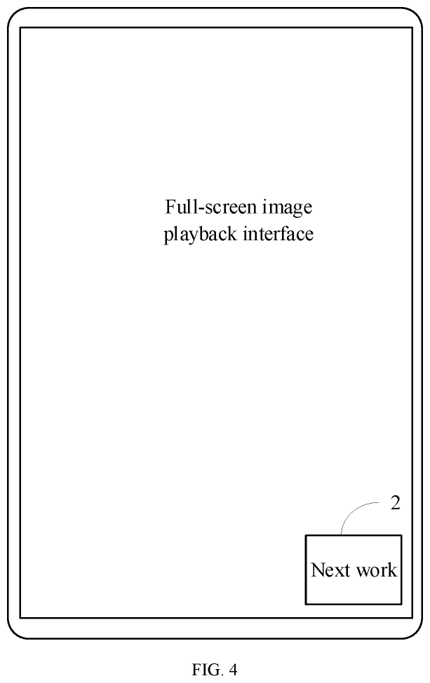

FIG. 4 is a schematic diagram of a display position of a next work control illustrated according to some arrangements of the present disclosure. As shown in FIG. 4, the second preset position can be the lower right corner position 2 of the full-screen image playback interface, i.e., the next work control is displayed in the lower right corner position of the full-screen image playback interface. If the user wants to view the next work (e.g., an image or a video), he or she may directly select (e.g., click) on the next work control. When the electronic device detects that the user selects (e.g., clicks) on the next work control, it is determined that an operation command for displaying the next work is received, and displays the next resource on the full-screen image playback interface. For example, when the user is viewing a long image, if he or she does not want to see the current long image any more, he or she can click the next work control in the bottom right corner of the interface to quickly switch to the next resource in the information flow list. When the user is viewing multiple images, he or she can click the next work control in the bottom right corner of the button interface or swipe up to switch to the next resource in the information flow list. Switching between different resources for display can be performed quickly based on the user's operation by displaying the next work control.

In another arrangement, after pausing the playback of the image group, the method further includes: displaying, in a first area of the full-screen image playback interface, a currently played image; and displaying, in a second area of the full-screen image playback interface, an image control bar corresponding to the image group.

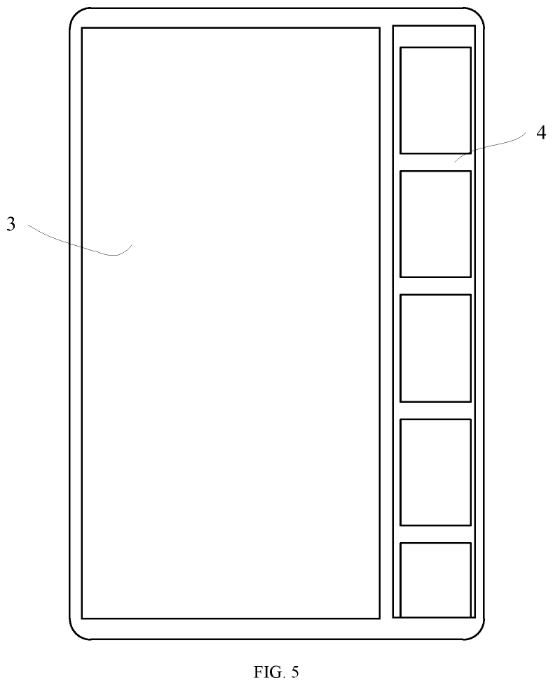

After receiving the pause command, the dynamic playback of the image group is paused, and the full-screen image playback interface is displayed in two areas, as shown in FIG. 5, one is the first area, i.e., the image area 3 and another is the second area, i.e., the control bar area 4. The image content currently being played is displayed in the image area 3, i.e., for a long image, the content of the long image within the display range of the long image when the pause command is received is displayed, while for multiple images or an image collection, the image that is played when the pause command is received is displayed. The image control bar corresponding to the image group is displayed in the control bar area 4. When the image group is the type of the long image, each positioning image of the long image is displayed in the image control bar. The positioning image may be an image with a normal size used for stitching the long image. When the image group is the type of the multi-image or the image collection, a thumbnail of each image in the image group is displayed in the image control bar, in this case, the positioning image or thumbnail of the adjacent resource of the image group may also be displayed by swiping the image control bar to the front or the end of the image group. Different operation areas can be provided to the user by displaying the first area and the second area separately on the full-screen image playback interface.

In some arrangements, after displaying image control bar corresponding to the image group, the method further includes one of the following.

In response to the type of the image group being a long image and receiving a drag command for the image control bar, a selection box on the image control bar is scrolled, and a display range displayed by the long image in the first area is changed by the scrolling of the selection box.

In response to the type of the image group being the long image and receiving a swipe command for the first area, the display range displayed by the image in the first area is changed, and the selection box on the image control bar is scrolled by the changing of the display range.

After pausing the dynamic effect of the image group, both the first area (e.g., the image area 3) and the second area (e.g., the control bar area 4) of the full-screen image playback interface are available for users to operate. If the type of the image group is a long image, the selection box of the positioning image corresponding to the currently displayed image in the image control bar displayed in the control bar area is selected, and the user can drag the selection box on the control bar up and down to change the selected positioning image, so that the electronic device receives the user's drag command to the image control bar, and controls the image control bar to scroll quickly based on the drag command, and the selection box on the image control bar is displayed. At this time, the display range displayed by the long image in the first area is scrolled in conjunction with the second, for example, when the user swipes up the image control bar, the image control bar is slid up in the control bar area 4, and the long image is controlled by the electronic device to slid up in the image area 3 at the same time. The user can also swipe up and down on the first area to change the display range of the long image displayed in the first area based on the user's swipe command, and at the same time, the selection box on the image control bar is interconnected with the display range of the first area for scrolling, for example, when the user swipes down the long image in the image area 3, the long image of the image area 3 is controlled by the electronic device to slid down simultaneously with the selection box on the image control bar. In the case where the type of the image group is the long image, the long image range displayed in the first area and the selection box on the image control bar can be slid and displayed at the same time based on the user's swipe command for the first area or the second area.

In some arrangements, after displaying image control bar corresponding to the image group, the method further includes one of the following.

In response to the type of the image group being multi-image or an image collection and receiving a drag command for the image control bar, a selection box on the image control bar is scrolled, and an image displayed in the first area is switchable by the scrolling of the selection box.

In response to the type of the image group being the multi-image or the image collection and receiving a swipe command for the image area, the image displayed in the first area is switchable, and the selection box on the image control bar is switchable by the switching of the image.

After pausing the dynamic effect of the image group, both the first area and the second area of the full-screen image playback interface are available for users to operate. If the type of the image group is the multi-image or the image collection, on the image control bar displayed in the second area, the selection box of the thumbnail corresponding to the currently displayed image is selected, and the user can drag the selection box on the control bar up and down to change the selected thumbnail, so that the electronic device receives the user's drag command to the image control bar. At this time, the image control bar is controlled by the electronic device to scroll quickly to display the selection box on the image control bar based on the drag command, and the image of the image group displayed in the first area is interconnected with the second area for switching. For example, when the user slides up the image control bar, the electronic device controls the image control bar to slide up in the control bar area 4, and switches from displaying the currently displayed image in the image area 3 to displaying the next image. The user can also swipe up and down on the first area to switch the image displayed in the image area based on the user's swipe command, and at the same time, the selection box on the image control bar is interconnected with the image in the image area for switching, for example, when the user swipes down the image in the image area 3, the electronic device controls the image in the image area 3 and the selection box on the image control bar to swipe down at the same time. When the type of image group is the multi-image or the image collection, based on the user's swipe command for the first area or second area, the image displayed in the first area and the selection box on the image control bar can be slid and switched at the same time.

In some arrangements, the second area further includes other image group of a same type as the image group. The method further includes: displaying, in response to a selection box on the image control bar in the second area sliding to a next image group, an image of the next image group in the first area.

The second area (e.g., the control bar area 4) can also display image control bars of other image groups of the same type as the image group. When the selection box on the image control bar in the second area is slid to the next image group based on the user's operation command, the image of the next image group corresponding to the selection box on the image control bar is displayed in the first area. By recommending other image groups of the same type as the image group in the second area, users can continuously view other long or multiple images.

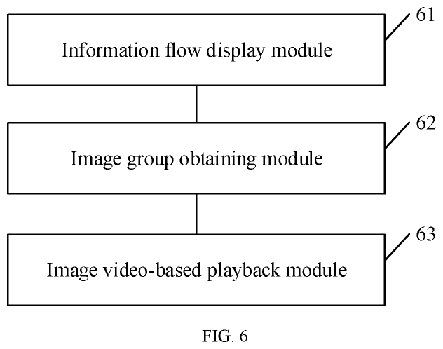

FIG. 6 is a block diagram of an apparatus for playing an image illustrated according to some arrangements of the present disclosure. Referring to FIG. 6, the apparatus for playing the image includes an information flow display module 61, an image group obtaining module 62, and an image video-based playback module 63.

The information flow display module 61 is configured to display, on a display interface of an information flow list, at least one resource in the information flow list.

The image group obtaining module 62 is configured to obtain, in response to a first resource of the at least one resource being an image group and a position of an image container containing the image group being within a preset range of a screen, at least one image of the image group.

The image video-based playback module 63 is configured to play, according to a type of the image group, the at least one image of the image group dynamically.

In some arrangements, the image video-based playback module includes at least one of following units: a long image playback unit configured to move, in response to the type of the image group being a long image, the long image of the image group dynamically upwards within the image container at a preset long image playback speed; a multi-image playback unit configured to switch, in response to the type of the image group being multi-image, the at least one image dynamically within the image container at a preset multi-image playback speed; and an image collection playback unit configured to switch, in response to the type of the image group being an image collection at least one image of each sub-image group in the image collection dynamically within the image container at a preset multi-image playback speed in an order of a plurality of sub-image groups in the image collection.

In some arrangements, the multi-image playback unit includes a dynamic switching subunit configured to change gradually from displaying the at least one image with a transparency of 100% to displaying the at least one image with a transparency of 0%; and change gradually, in response to the at least one image being displayed for a preset time with the transparency of 0%, to display the at least one image with the transparency of 100%.

In some arrangements, the apparatus further includes a first loop playback module configured to play, in response to the type of the image group being the long image or the multi-image and the at least one image of the image group having been displayed, the at least one image on a loop according to a playback form of the long image or the multi-image.

In some arrangements, the apparatus further includes a second loop playback module configured to play, in response to the type of the image group being the image collection and the plurality of sub-image groups in the image collection having been displayed, the at least one image of each sub-image group in the image collection on a loop according to a playback form of the image collection.

In some arrangements, the apparatus further includes a full screen playback module configured to obtain, in response to a full-screen playback command for the image group, a current playback position of a current image of the at least one image in an image playback sequence of the image group, and play, on a full-screen image playback interface, the at least one image of the image group in full screen from the current playback position.

In some arrangements, the apparatus further includes a resource switching module configured to play, in response to a resource switching command, on the full-screen image playback interface, a second resource in the information flow list, where a type of the second resource includes an image resource, a video resource or a live streaming resource.

In some arrangements, the apparatus further includes an information control display module configured to display, on the full-screen image playback interface, interface text information and an interactive function control of the image group; and a pause playback module configured to pause, in response to a pause command, playback of the image group, and hide the interface text information and the interactive function control.

In some arrangements, the pause playback module includes a long image pause playback module configured to determine, in response to the type of the image group being a long image, a current display range of the long image when the pause command is received, and display the long image within the current display range; and a multi-image pause playback module configured to determine, in response to the type of the image group being multi-image or an image collection, a currently displayed image when the pause command is received, and display the currently displayed image.

In some arrangements, the apparatus further includes an image view interactive module configured to perform at least one of following acts: changing, in response to the type of the image group being the long image and receiving an up and down swipe command, a display range of the long image by moving the long image with the up and down swipe command; and displaying, in response to the type of the image group being the multi-image or the image collection and receiving a left and right swipe command, a previous image or a next image of the currently displayed image.

In some arrangements, the apparatus further includes an image operation control display module configured to display, at a first preset position of the full-screen image playback interface, an image operation control, the image operation control including at least one of a favorite image control, a download image control and a recognize image text control; and in response to the image operation control being triggered, perform an operation on the image group.

In some arrangements, the apparatus further includes a next work control display module configured to display, at a second preset position of the full-screen image playback interface, a next work control; and in response to the next work control being triggered, display a next resource in the information flow list.

In some arrangements, the apparatus further includes a first area display module configured to display, in a first area of the full-screen image playback interface, a currently played image; and a second area display module configured to display, in a second area of the full-screen image playback interface, an image control bar corresponding to the image group.

In some arrangements, the apparatus further includes a long image linkage display module configured to scroll, in response to the type of the image group being a long image and receiving a drag command for the image control bar, a selection box on the image control bar, and change a display range displayed by the long image in the first area by the scrolling of the selection box; or change, in response to the type of the image group being the long image type and receiving a swipe command for the first area, the display range displayed by the image in the first area, and scroll the selection box on the image control bar by the changing of the display range.

In some arrangements, the apparatus further includes a multi-image linkage display module configured to scroll, in response to the type of the image group being multi-image or an image collection and receiving a drag command for the image control bar, a selection box on the image control bar, and switch an image displayed in the first area by scrolling of the selection box; or switch, in response to the type of the image group being the multi-image or the image collection and receiving a swipe command for the first area, the image displayed in the first area, and switch the selection box on the image control bar by the switching of the image.

In some arrangements, the control bar area further includes other image group of a same type as the image group, and the apparatus further includes a next image group display module configured to display, in response to a selection box on the image control bar in the second area sliding to a next image group, an image of the next image group in the first area.

In some arrangements, the apparatus further includes an audio playback module configured to play, during dynamically playing the at least one image of the image group, an audio resource corresponding to the image group.

In some arrangements, the information flow list includes an image resource, and further includes at least one of a video resource and a live streaming resource.

Regarding the apparatus in the above arrangements, the specific manner in which each module performs operations has been described in detail in the arrangements of the method, and will not be described in detail here.

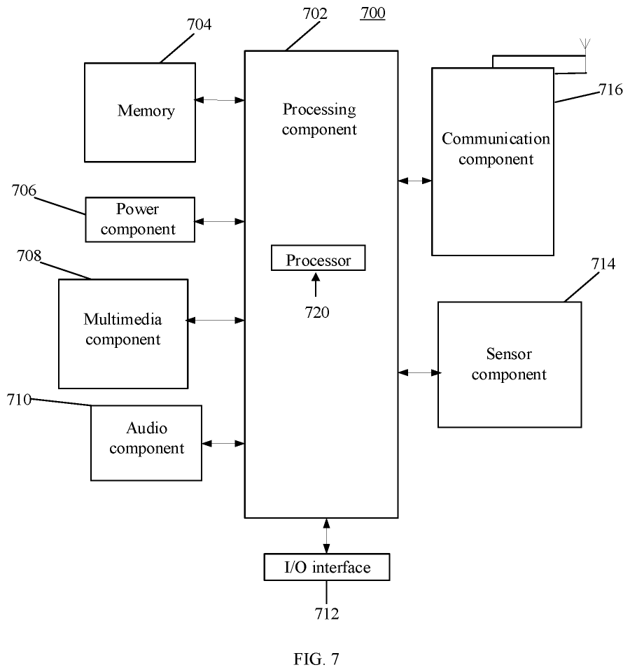

FIG. 7 is a block diagram of an electronic device illustrated according to some arrangements of the present disclosure. For example, the electronic device 700 may be may be a cell phone, a computer, a digital broadcast terminal, a message sending and receiving device, a game console, a tablet device, a medical device, a fitness device, a personal digital assistant, and the like.

Referring to FIG. 7, the electronic device 700 may include one or more of the following components: a processing component 702, a memory 704, a power component 706, a multimedia component 708, an audio component 710, an input/output (I/O) interface 712, a sensor component 714, and a communication component 716.

The processing component 702 typically controls the overall operation of the electronic device 700, such as operations associated with display, phone call, data communication, camera operation, and recording operations. The processing component 702 may include one or more processors 720 to execute instructions to complete all or some of the method described above. In addition, the processing component 702 may include one or more modules that facilitate interaction between processing component 702 and other components. For example, processing component 702 may include a multimedia module to facilitate interaction between multimedia component 708 and processing component 702.

The memory 704 is configured to store various types of data to support operation at the electronic device 700. Examples of such data include instructions for any application or method of operation on the electronic device 700, contact data, phonebook data, messages, images, videos, etc. The memory 704 can be implemented by any type of transitory or non-transitory storage device or a combination of them, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or CD.

The power component 706 provides power to the various components of the electronic device 700. The power component 706 may include a power management system, one or more power supplies, and other components associated with generating, managing, and distributing power for the electronic device 700.

The multimedia component 708 includes a screen providing an output interface between the electronic device 700 and the user. In some arrangements, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensors may not only sense the boundaries of the touch or swipe action, but also detect the duration and pressure associated with the touch or swipe action. In some arrangements, the multimedia component 708 includes a front-facing camera and/or a rear-facing camera. The front camera and/or rear camera can receive external multimedia data when the electronic device 700 is in an operating mode, such as shooting mode or video mode. Each front camera and rear camera may be a fixed optical lens system or have focal length and optical zoom capability.

The audio component 710 is configured to output and/or input audio signals. For example, the audio component 710 includes a microphone (MIC) configured to receive external audio signals when the electronic device 700 is in an operating mode, such as call mode, recording mode, and voice recognition mode. The received audio signal may be further stored in memory 704 or sent via communication component 716. In some arrangements, the audio component 710 further includes a speaker for outputting audio signals.

The I/O interface 712 provides an interface between the processing component 702 and a peripheral interface module. The peripheral interface module may be a keyboard, click wheel, button, etc. These buttons may include, but are not limited to, a home button, a volume button, a start button, and a lock button.

The sensor component 714 includes one or more sensors for providing status assessment of various aspects of the electronic device 700. For example, the sensor component 714 may detect an open/closed state of the device 700, the relative positioning of components, such as the components being the display and keypad of the electronic device 700, the sensor component 714 may also detect a change in position of the electronic device 700 or a component of the electronic device 700, the presence or absence of user contact with the electronic device 700, the orientation or acceleration/deceleration of the electronic device 700 and temperature changes of the electronic device 700. The sensor component 714 may include a proximity sensor configured to detect the presence of a nearby object in the absence of any physical contact. The sensor component 714 may also include a light sensor, such as a CMOS or CCD image sensor, for use in imaging applications. In some arrangements, the sensor component 714 may also include an accelerometer sensor, a gyroscope sensor, a magnetic sensor, a pressure sensor, or a temperature sensor.

The communication component 716 is configured to facilitate communication between the electronic device 700 and other devices by wired or wireless means. The electronic device 700 may access a wireless network based on a communication standard, such as WiFi, operator network (e.g., 2G, 3G, 4G, 5G), or a combination thereof. In one arrangement, communication component 716 receives broadcast signals or broadcast-related information from an external broadcast management system via a broadcast channel. In an arrangement, the communication component 716 further includes a near-field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In some arrangements, the electronic device 700 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components for performing above mentioned method for playing the image.

In some arrangements, there is also provided a non-transitory computer readable storage medium including instructions, such as a memory 704 including instructions, the instructions being executable by the processor 720 of the electronic device 700 to accomplish the method for playing the image described above. For example, the non-transitory computer readable storage medium may be ROM, random access memory (RAM), CD-ROM, magnetic tape, floppy disk, and optical data storage devices, among others.

In some arrangements, there is also provided a computer program product including a computer program or computer instructions, where the computer program or computer instructions, when executed by a processor, implements the method for playing the image described above.

In the above arrangements of the present disclosure, at least one image of the image group is played dynamically on the display interface of the information flow list according to the type of the image group in response to the current position of the image container containing the image group being within a preset range of the screen, which realizes automatic playback of all images in the image group, and the user can view the complete content of the image group without operation. Thus, the user operation is simplified and the user experience can be improved. As all the images in the image group are played in the form of video, it further realizes that image resources and video resources are played by a unified player, allowing the mixed recommendation for images, videos, live streaming contents, etc.

Other arrangements of the present disclosure will readily be anticipated by those skilled in the art upon consideration of the specification and practice of the invention disclosed herein. This application is intended to cover any variations, uses, or adaptations of the present disclosure that follow the general principles of the present disclosure and include common knowledge or techniques in the technical field not disclosed by the present disclosure. The specification and examples are to be regarded as example only, and the true scope and spirit of the disclosure being indicated by the following claims.

It should be understood that the present disclosure is not limited to the precise structures described above and illustrated in the accompanying drawings, and that various modifications and changes may be made without departing from the scope thereof. The scope of the present disclosure is limited only by the scope of the appended claims.

What is claimed is:

1. A method for playing an image, comprising:
displaying, on a display interface of an information flow list, at least one resource in the information flow list;
obtaining, in response to a first resource of the at least one resource being an image group and a position of an image container containing the image group being within a preset range of a screen, at least one image of the image group; and
playing, according to a type of the image group, the at least one image of the image group dynamically.

2. The method of claim 1, wherein the playing, according to the type of the image group, the at least one image of the image group dynamically, comprises at least one of:
moving, in response to the type of the image group being a long image, the long image of the image group dynamically upwards within the image container at a preset long image playback speed;
switching, in response to the type of the image group being multi-image, the at least one image dynamically within the image container at a preset multi-image playback speed; and
switching, in response to the type of the image group being an image collection, the at least one image of each sub-image group in the image collection dynamically within the image container at a preset multi-image playback speed in an order of a plurality of sub-image groups in the image collection.

3. The method of claim 2, wherein switching the at least one image dynamically within the image container, comprises:
changing gradually from displaying the at least one image with a transparency of 100% to displaying the at least one image with a transparency of 0%; and
changing gradually, in response to the at least one image being displayed for a preset time with the transparency of 0%, to display the at least one image with the transparency of 100%.

4. The method of claim 2, further comprising at least one of:
playing, in response to the type of the image group being the long image or the multi-image and the at least one image of the image group having been displayed, the at least one image on a loop according to a playback form of the long image or the multi-image; and
playing, in response to the type of the image group being the image collection and the plurality of sub-image groups in the image collection having been displayed, the at least one image of each sub-image group in the image collection on a loop according to a playback form of the image collection.

5. The method of claim 1, further comprising:
obtaining, in response to a full-screen playback command for the image group, a current playback position of a current image of the at least one image in an image playback sequence of the image group, and
playing, on a full-screen image playback interface, the at least one image of the image group in full screen from the current playback position.

6. The method of claim 5, further comprising:
playing, in response to a resource switching command, on the full-screen image playback interface, a second resource in the information flow list, wherein a type of the second resource comprises an image resource, a video resource or a live streaming resource.

7. The method of claim 5, further comprising:
displaying, on the full-screen image playback interface, interface text information and an interactive function control of the image group; and
pausing, in response to a pause command, playback of the image group, and hiding the interface text information and the interactive function control.

8. The method of claim 7, wherein the pausing the playback of the image group comprises at least one of:
determining, in response to the type of the image group being a long image, a current display range of the long image when the pause command is received, and displaying the long image within the current display range; and
determining, in response to the type of the image group being multi-image or an image collection, a currently displayed image when the pause command is received, and displaying the currently displayed image.

9. The method of claim 8, further comprising at least one of:
changing, in response to the type of the image group being the long image and receiving an up and down swipe command, a display range of the long image by moving the long image with the up and down swipe command; and
displaying, in response to the type of the image group being the multi-image or the image collection and receiving a left and right swipe command, a previous image or a next image of the currently displayed image.

10. The method of claim 7, wherein after hiding the interface text information and the interactive function control, the method further comprises at least one of:
displaying, at a first preset position of the full-screen image playback interface, an image operation control, the image operation control comprising at least one of a favorite image control, a download image control and a recognize image text control; and in response to the image operation control being triggered, performing an operation on the image group; and
displaying, at a second preset position of the full-screen image playback interface, a next work control; and in response to the next work control being triggered, displaying a next resource in the information flow list.

11. The method of claim 7, wherein after pausing the playback of the image group, the method further comprises:
displaying, in a first area of the full-screen image playback interface, a currently played image; and
displaying, in a second area of the full-screen image playback interface, an image control bar corresponding to the image group.

12. The method of claim 11, wherein after displaying the image control bar corresponding to the image group, the method further comprises:
scrolling, in response to the type of the image group being a long image and receiving a drag command for the image control bar, a selection box on the image control bar, and changing a display range displayed by the long image in the first area by the scrolling of the selection box; or
changing, in response to the type of the image group being the long image and receiving a swipe command for the first area, the display range displayed by the image in the first area, and scrolling the selection box on the image control bar by the changing of the display range.

13. The method of claim 11, wherein after displaying image control bar corresponding to the image group, the method further comprises:
scrolling, in response to the type of the image group being multi-image or an image collection and receiving a drag command for the image control bar, a selection box on the image control bar, and switching an image displayed in the first area by the scrolling of the selection box; or
switching, in response to the type of the image group being the multi-image or the image collection and receiving a swipe command for the first area, the image displayed in the first area, and switching the selection box on the image control bar by the switching of the image.

14. The method of claim 11, wherein the second area further comprises other image group of a same type as the image group; and
the method further comprises:
displaying, in response to a selection box on the image control bar in the second area sliding to a next image group, an image of the next image group in the first area.

15. The method of claim 1, further comprising:
playing, during dynamically playing the at least one image of the image group, an audio resource corresponding to the image group.

16. The method of claim 1, wherein the information flow list comprises an image resource, and further comprises at least one of a video resource and a live streaming resource.

17. An electronic device, comprising:
a processor; and
a memory for storing instructions executable by the processor;
wherein the processor is configured to execute the instructions to:
display, on a display interface of an information flow list, at least one resource in the information flow list;
obtain, in response to a first resource of the at least one resource being an image group and a position of an image container containing the image group being within a preset range of a screen, at least one image of the image group; and
play, according to a type of the image group, the at least one image of the image group dynamically.

18. The electronic device of claim 17, wherein the processor is further configured to perform at least one of following acts:
moving, in response to the type of the image group being a long image, the long image of the image group dynamically upwards within the image container at a preset long image playback speed;
switching, in response to the type of the image group being multi-image, the at least one image dynamically within the image container at a preset multi-image playback speed; and
switching, in response to the type of the image group being an image collection, the at least one image of each sub-image group in the image collection dynamically within the image container at a preset multi-image playback speed in an order of a plurality of sub-image groups in the image collection.

19. The electronic device of claim 17, wherein the processor is further configured to:
obtain, in response to a full-screen playback command for the image group, a current playback position of a current image in an image playback sequence of the image group, and
play, on a full-screen image playback interface, at least one image of the image group in full screen from the current playback position.

20. A non-transitory computer readable storage medium, wherein instructions in the computer readable storage medium, when executed by a processor of an electronic device, enables the electronic device to perform following acts:
displaying, on a display interface of an information flow list, at least one resource in the information flow list;
obtaining, in response to a first resource of the at least one resource is an image group and a position of an image container containing the image group is within a preset range of a screen, at least one image of the image group; and
playing, according to a type of the image group, the at least one image of the image group dynamically.
